(19) United States
(12) Patent Application Publication
(10) Pub. No.: US 2015/0068371 A1
(43) Pub. Date: Mar. 12, 2015

(54) CLEANING IMPLEMENT

(71) Applicant: Hyacinth Claire Terrelonge, Ellenwood, GA (US)

(72) Inventor: Hyacinth Claire Terrelonge, Ellenwood, GA (US)

(21) Appl. No.: 14/480,687

(22) Filed: Sep. 9, 2014

Related U.S. Application Data
(60) Provisional application No. 61/960,028, filed on Sep. 9, 2013.

(51) Int. Cl. B25G 1/10

(52) U.S. Cl. CPC B25G 1/10
USPC 81/489

(57) ABSTRACT

A cleaning implement to facilitate household cleaning for individuals with physical impairments. The cleaning implement comprises a handle member comprising an elongate body with a first end, a second end, and a longitudinal axis extending therebetween. The handle member forms an interface extending laterally away from and the longitudinal axis to a side portion that is laterally offset from the longitudinal axis. The interface having a landing surface disposed between the longitudinal axis and the side portion. The cleaning implement further comprises a coupling member disposed on the second end of the elongate body, the coupling member and an end effector coupled with the coupling member. In one example, the handle portion is disposed on a first side of a plane that extends along the longitudinal axis and at least half of the end effector is disposed on a second side of the plane that extends along the longitudinal axis.

### CROSS-REFERENCE TO RELATED APPLICATIONS

This application claims the benefit of priority to U.S. Provisional Patent Application Ser. No. 61/960,028, filed on Sep. 9, 2013, and entitled “BATHROOM BRIZZIO.” The content of this provisional application is incorporated by reference herein in its entirety.

### BACKGROUND

The subject matter disclosed herein relates to cleaning tools for household use, with particular discussion about embodiments of a cleaning implement that is configured with a handle that offers improved mechanical advantage to direct loading from the end user on one end of the handle to an end effector located on the other end of the handle.

It is well-known that physical impairments, whether induced naturally or by way of injury or aging, can severely restrict the strength and/or stamina of an individual. These impairments can frustrate the ability of the individual to perform many daily tasks. Often, the individual cannot expend the effort necessary to properly clean and maintain conditions in the household. This shortcoming may require the individual to enlist help (e.g., a housekeeper) or, worse, cause the individual to move to a residence with assisted-living or similar arrangements.

### BRIEF DESCRIPTION OF THE INVENTION

The embodiments below describe cleaning implements that incorporate features meant to alleviate at least some of these problems. These features can allow individuals to maintain or regain their independent lifestyle. For the public at large, on the other hand, the cleaning implements in this disclosure may prove superior to conventional devices. Notably, the cleaning implements are configured in a way that better directs loading on the handle to the cleaning end and, ultimately, to the brush and/or end effector disposed thereon. These configurations operate as a “force-multiplier” that can increase the effectiveness with which the end effector dislodges dirt, grime, and debris from a surface.

### BRIEF DESCRIPTION OF THE DRAWINGS

Reference is now made briefly to the accompanying drawings, in which:

FIG. 1 depicts an elevation view of a side of an exemplary embodiment of a cleaning implement;

FIG. 2 depicts a detail view of the cleaning implement of FIG. 1 to focus on details of an example of a handle;

FIG. 3 depicts a perspective view of the cleaning implement of FIG. 1 in one application in a portion of the household;

FIG. 4 depicts a detail view of the cleaning implement of FIG. 1 that focuses on details of an example of a end effector;

FIG. 5 depicts a bottom view of the end effector of FIG. 4 to illustrate one arrangement of cleaning elements (e.g., bristles); and

FIG. 6 depicts a bottom view of the end effector of FIG. 4 to illustrate one arrangement of cleaning elements (e.g., bristles).

Where applicable like reference characters designate identical or corresponding components and units throughout the several views, which are not to scale unless otherwise indicated.

### DETAILED DESCRIPTION

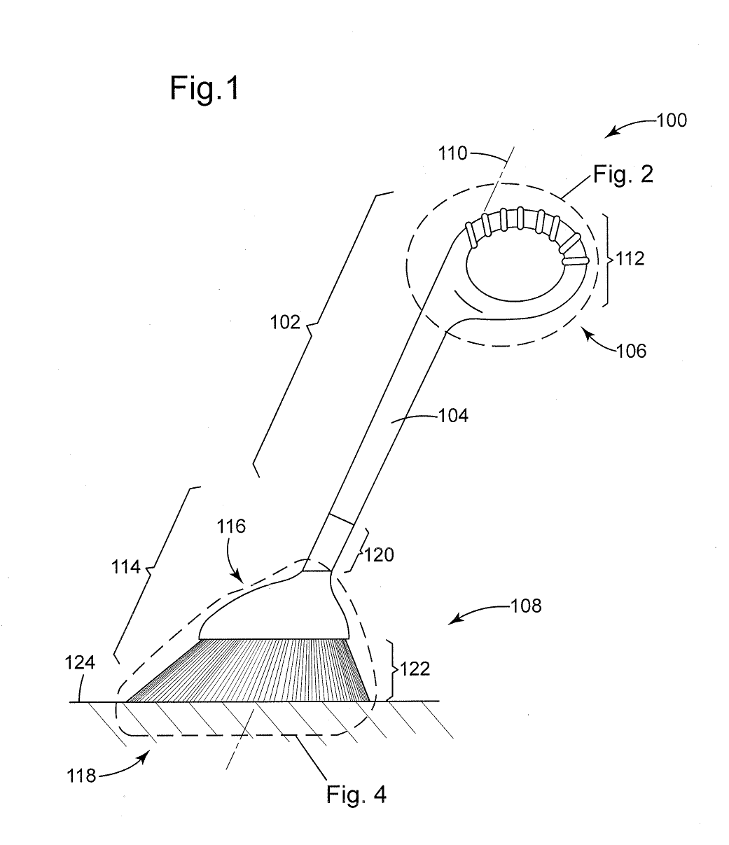

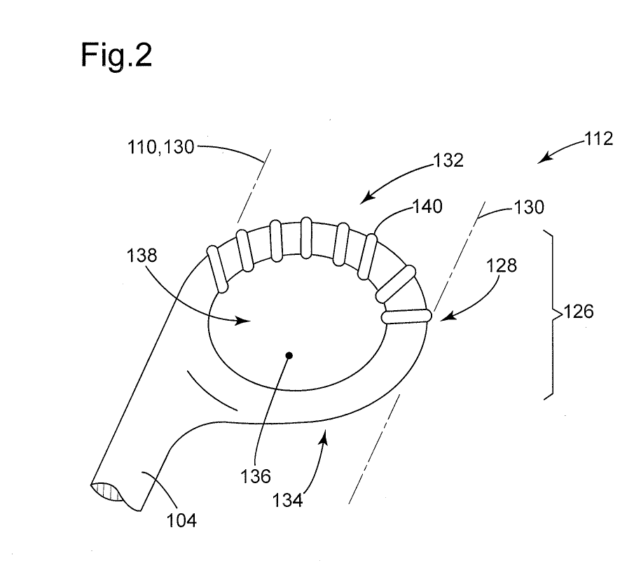

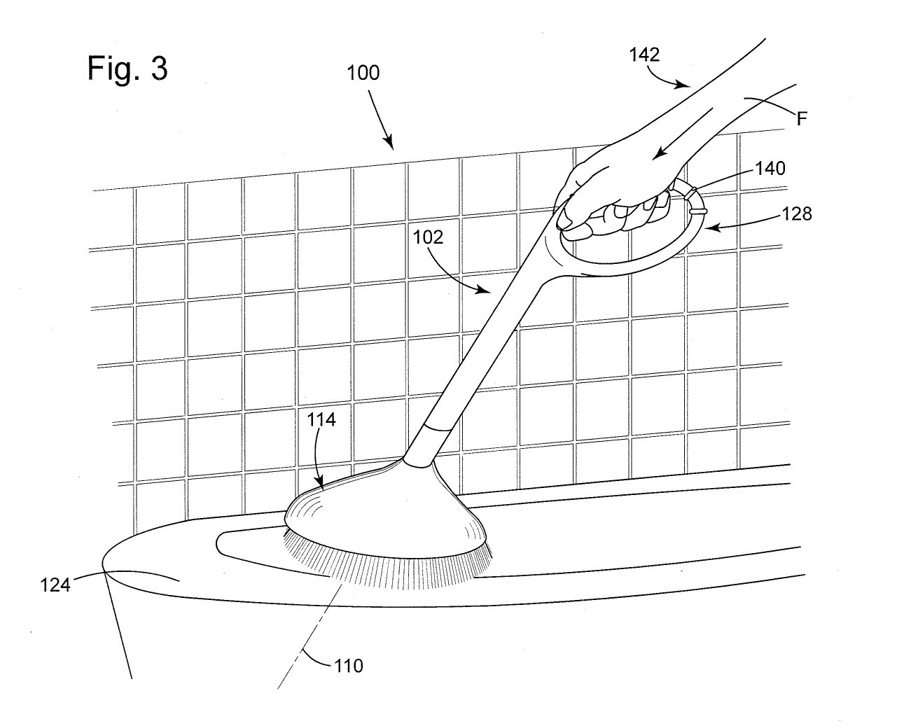

FIGS. 1, 2, and 3 depict various views of an exemplary embodiment of a cleaning implement 100 that can better direct loading to improve cleaning effectiveness. FIG. 1 shows an elevation view of a side of the embodiment. FIG. 2 focuses on certain details of the cleaning implement 100. FIG. 3 depicts a perspective view of the embodiment in one application for household cleaning.

Turning first to FIG. 1, the embodiment includes a handle member 102 with an elongate body 104 that has a first end 106, a second end 108, and a longitudinal axis 110 extending therebetween. The first end 106 can include a handle portion 112 that serves as an interface for an end user to grasp the cleaning implement 100. At the second end 108, the elongate body 104 couples with an end effector 114. The end effector 114 can have a top 116 and a bottom 118. In one example, the cleaning implement 100 employs a coupling member 120 that is useful to releasably attach the top 116 of the end effector 114 to the first end 106 of the elongate body 104. This feature allows the end user to readily remove and replace the end effector 114 from the second end 108 of the elongate body 104. The bottom 118 of the end effector 114 can have a cleaning member 122 that can comprise elements (e.g., bristles, fabric, strings, yarn, etc.) in arrangements that might facilitate cleaning of certain types of debris and/or certain portions of the household. In use, these elements come in contact with a target surface, generally identified by the numeral 124.

The coupling member 120 can help configure the cleaning implement 100 for particular use in the household. Broadly, the coupling member 120 can include one or more parts that integrate together to allow the end user to secure and unsecure the end effector 114 from the elongate body 104. This feature helps adapt the device to a particular cleaning task, namely, to receive different configuration for the end effectors 114 that define different arrangements of the cleaning member 122. Examples of these parts can include a first part and a second part, one each disposed on the elongate body 104 and the end effector 114. These parts may be configured, e.g., with complimentary threads, to connect with one another to install and un-install the end effector 114 to and from the elongate body 104. These configurations could also employ other mechanisms (e.g., latches, clasps, fasteners) that are purpose built to releasably secure two parts together.

Construction of the elongate body 104, and the cleaning implement 100 in general, is often consistent with products in the consumer industry. Focus on cost, consumer preference, and efficiencies, among other factors, may drive a selection of certain materials over others. These materials can comprise plastics and/or composites; however, this disclosure does consider the myriad alternatives (e.g., metals) that might better suit certain implementations. From an assembly perspective, the handle member 102 may comprise one or more pieces that are formed integrally with one another or separately assembled using known and/or practical fastening techniques; for example, the elongate body 104 and handle portion 112 may be formed (e.g., molded) monolithically.

The handle portion 112 may be uniquely configured to better leverage the force that the end user applies to the cleaning implement 100. As best shown in FIG. 2, the handle portion 112 forms an interface 126 that extends outward from the elongate body 104. This configuration provides a landing surface for the hand of an end user. In one example, this landing surface extends convexly away from the surface 124 to form an arc between the longitudinal axis 110 and a side portion 128 of the interface 126 that is laterally offset from the longitudinal axis 110. This arc can define a series of points of the landing surface that are disposed above the point of integration with the elongate body 104 along the longitudinal axis 110. For reference, the lateral offset is measured between a pair 130 of parallel planes, one plane extending through the longitudinal axis 110 and one plane that is tangent to at least one point on the interface 126. The interface 126 can also have one or more interface members (e.g., a top member 132 and bottom member 134), which can couple at a first end with the elongate body 104. The members 132, 134 can also couple at a second end with each other to form the side portion 128 of the interface 126. In one configuration, the members 132, 134 circumscribe an axis 136, also laterally offset from the longitudinal axis 110, thereby forming an opening 138. The top member 132 can be outfit with a grip 140 that forms at least part of the landing surface. The grip 140 can define one or more properties and/or parameters of the landing surface, typically surface properties that offer higher friction and/or adhesion to prevent the end user's hand from slipping from the interface 126 and softness (or hardness) to offer comfort and feel.

FIG. 3 shows the cleaning implement in position to clean a portion of the household. The end user's hand (identified here by the numeral 142) is shown in position to grasp the grip 140. During use, the end user applies a force F onto the landing surface, typical loading the handle member 102 to drive the end effector 114 in a back-and-forth motion on the surface 124. As shown, the side portion 128 is spaced sufficiently from the longitudinal axis 110 to allow substantially all of the end user's hand to press firmly onto the landing surface. This configuration distributes the force F across interface 126. This feature may in turn provide the end user with a device that is likely more efficient in the transmission of force onto the end effector 114 and more ergonomic to avoid fatigue and/or pain as compared to conventional devices, i.e., those having configuration in which the end effector is effectively “in-line” (or “not offset”) from the handle.

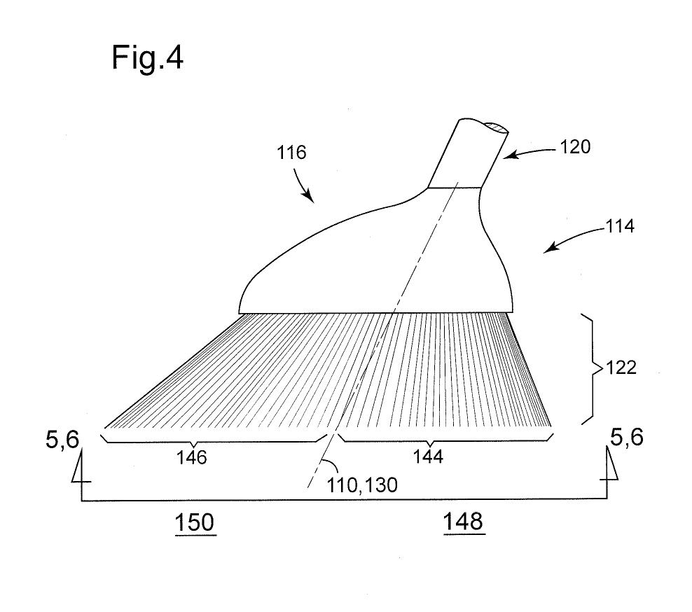

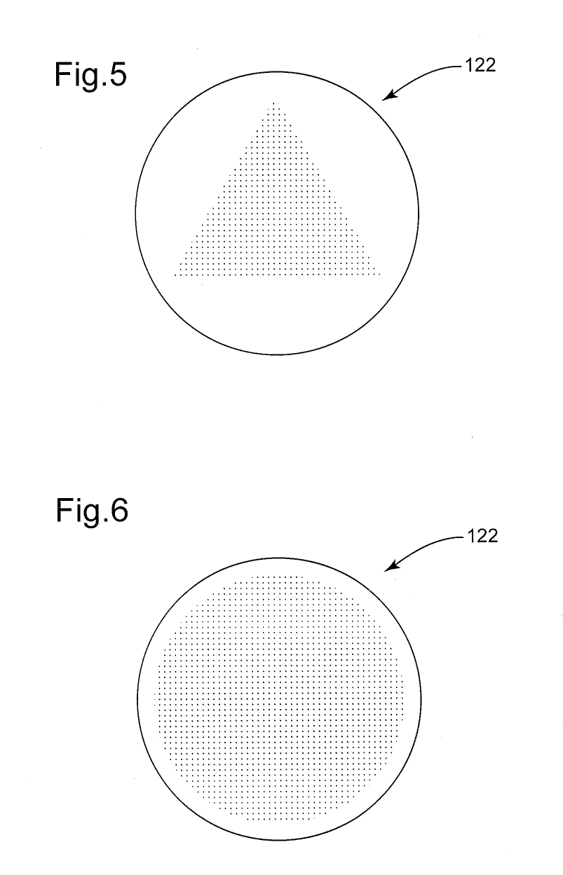

FIGS. 4, 5, and 6 depict a detail view of the end effector 114. FIG. 4 shows a side, elevation view to exemplify the overall construction of the end effector 114. FIGS. 5 and 6 show a bottom view of the end effector 114 to illustrate different configurations of the cleaning member 122. Broadly, these arrangements for the cleaning member 122 might find use particular to the portion of the household.

FIG. 4 shows that the top 116 of the end effector 114 can form a body, or housing, that integrates with one part of the coupling member 120. This body can incorporate design features (e.g., curves, shapes, sweeping lines, etc.) that are pleasing to the eye. In some respects, however, the overall shape of the end effector 114 may configured to fit certain areas and/or reach portions of the household, as desired. The bottom 118 of the end effector 114 can provide a platform to receive and secure the elements (e.g., bristles) of the cleaning member 122. This platform may securely attach the elements, i.e., meaning that the bristles are likely to disengage from the platform unless broken and/or otherwise dislodged. On the other hand, this disclosure does contemplate configurations for the platform that allows the elements to detach, either individually or as a collective. This type of configuration can permit the arrangement of the elements to change but retain the end effector 114 on the handle member 102 (FIG. 1).

With reference also to FIG. 1, FIG. 4 includes details that highlight the beneficial arrangement of the end effector 114 relative to the handle portion 112 (FIG. 1). The end effector 114 has a first portion 144 and a second portion 146, one each disposed, respectively, on a first side 148 and a second side 150 of the plane 130 that extends along the longitudinal axis 110. The handle portion 112 (FIG. 1) is also disposed on the first side 144. The coupling member 120 connects with the end effector 114 in alignment with the longitudinal axis 110. The position of connection is typically at, or near, the apex of the top 116, with the surface of the end effector 114 sloping generally downwardly from the position of connection (toward the surface 124 of FIG. 1) in the direction of both the first portion 144 and the second portion 146. In one implementation, the second portion 146 is larger than the first portion 144, with at least half of the end effector 114 disposed on the second side 150 of the plane 130. Depending on the arrangement of the cleaning elements (e.g., bristles), this configuration can position a majority of the cleaning member 122 on the second side 146.

FIGS. 5 and 6 identify two arrangements for the elements. Collectively, the arrangements can dispose the cleaning elements about the bottom surface of the end effector 114. These cleaning elements can populate substantially all of the bottom surface, however, in some alternatives, the cleaning elements circumscribe an area that is devoid, or lacking, substantially any cleaning elements. FIGS. 5 and 6 illustrate two such configurations. As shown in FIG. 5, one arrangement may configure the elements to extend and/or reach into corners. This configuration may take a form factor that has a triangular shape (as shown), although other forms factors might alternatively provide the same and/or similar advantages to reach areas with limited access. In the arrangement in FIG. 6, the form factor embodies a larger surface area that might better suit cleaning of surfaces having extensive surface area. This form factor may have a circular shape (as shown) or other shapes, as desired.

As noted above, selection of the elements may coincide with the purpose and/or use of the end effector 114 (or cleaning member 122). This selection can consider various properties of the elements, namely, physical properties (e.g., stiffness), material properties (e.g., porosity), length, diameter, and the like. The cleaning member 122 may deploy cleaning elements homegenously, wherein the cleaning elements exhibit substantially the same and/or similar properties. On the other hand, some benefit may be gained by mixing together cleaning elements of different properties. Notably, this disclosure contemplates both constructions that populate only the peripheral edge of the form factor with elements (as shown) and constructions that selectively populate other areas and/or the entire area of the form factor.

The embodiments herein contemplate implementation of the cleaning implement 100 as a kit and/or system. This kit can include the handle portion along with one or more end effectors (e.g., a first end effector or a second end effector). As noted herein, the first end effector and the second end effector may be configured with different arrangement of the cleaning elements to address different cleaning needs.

In light of the foregoing, the embodiments described herein are configured to improve cleaning effectiveness over conventional devices. These embodiments can distribute force from in a way that can better leverage the loading from the end user to clean and scrub the target surface. This feature can reduce the loading necessary from the end user, thus potentially reducing fatigue while at a minimum providing a device that can address the needs of individuals with physical impairments.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A cleaning implement, comprising:
a handle member comprising an elongate body with a first end, a second end, and a longitudinal axis extending therebetween, the handle member comprising a handle portion disposed on the first end, the handle portion forming an interface extending laterally away from and the longitudinal axis to a side portion that is laterally offset from the longitudinal axis and that forms the lateral extent of the handle portion, the interface having a landing surface disposed between the longitudinal axis and the side portion, the landing surface having a grip disposed thereon;
a coupling member disposed on the second end of the elongate body; and
an end effector coupled with the coupling member,
wherein the coupling member is configured to releasably engage the end effector, and
wherein the handle portion is disposed on a first side of a plane that extends along the longitudinal axis and at least half of the end effector is disposed on a second side of the plane that extends along the longitudinal axis.

2. The cleaning implement of claim 1, wherein the interface comprise a first member and a second member that couple with one another at the side portion.

3. The cleaning implement of claim 2, wherein the first member and the second member are formed integrally with the handle member.

4. The cleaning implement of claim 3, wherein the first member and the second member are formed integrally at the side portion.

5. The cleaning implement of claim 2, where the first member forms the landing surface, and wherein the first member forms an arc from a point at which the first member couples with the elongate body.

6. The cleaning implement of claim 2, further comprising a grip disposed on the first member, the grip having surface properties that are different from surface properties of the first member.

7. The cleaning implement of claim 1, wherein the end effector comprises a cleaning member that secures to the bottom thereof, wherein the cleaning member has a plurality of cleaning elements disposed circumferentially to form an inner area devoid of cleaning elements.

8. The cleaning implement of claim 1, wherein the coupling mechanism comprises a first part and a second part, one each disposed on the first end of the elongate body and the end effector, respectively, and wherein the first part and the second part are configured to engage one another to allow the end effector to secure and un-secure to and from the elongate body.

9. The cleaning implement of claim 8, wherein the first part and the second part comprise threads that are configured to engage and disengage.

10. The cleaning implement of claim 1, wherein the plurality of cleaning elements form a form factor, and wherein substantially all of the form factor is disposed on the second side of the plane that extends along the longitudinal axis.

11. A cleaning implement, comprising:
an elongate body with a first end, a second end, and a longitudinal axis extending therebetween;
a handle portion formed integrally with the first end of the elongate body;
a first coupling member secured to the second end of the elongate body; and
an end effector with a second coupling member configured to releasably engage with the first coupling member,
wherein the handle portion extends away from a first point proximate the longitudinal axis to a second point disposed at side portion that is laterally offset from the longitudinal axis and that forms the lateral extent of the handle portion, the handle portion forming a landing surface formed convexly with at least one point disposed above both of the first point and the second point on the handle portion, and
wherein the handle portion is disposed on a first side of a plane that extends along the longitudinal axis and at least half of the end effector is disposed on a second side of the plane that extends along the longitudinal axis with the first coupling member and the second coupling member engaged with one another.

12. The cleaning implement of claim 11, wherein the interface comprise a first member and a second member that couple with one another at the side portion.

13. The cleaning implement of claim 12, wherein the first member and the second member are formed integrally with the handle member.

14. The cleaning implement of claim 13, wherein the first member and the second member are formed integrally at the side portion.

15. The cleaning implement of claim 12, where the first member forms the landing surface, wherein the first member forms an arc from a point at which the first member couples with the elongate body the side portion.

16. A kit, comprising:
a handle member comprising an elongate body with two ends and a longitudinal axis, the elongate body having an interface on one of the two ends and a coupling mechanism on one of the two ends, the interface having a first member and a second member that circumscribe an axis to form an opening, the axis offset laterally from the longitudinal axis, the coupling mechanism comprising a first part with threads, wherein the handle member is disposed on a first side of a plane that extends along the longitudinal axis;
a first end effector having a top and a bottom, the top comprising a second part with threads that are configured to engage the threads on the first part, the bottom having a cleaning member disposed on the bottom, the cleaning member configured with a plurality of cleaning elements disposed thereon,
wherein, with the first part and the second part engaged, at least half of the end effector is disposed on a second side of the plane that extends along the longitudinal axis.

17. The kit of claim 16, wherein the first member and the second member are formed integrally with the elongate body and with one another.

18. The kit of claim 16, further comprising a second end effector having a top and a bottom, the top comprising a second part with threads that are configured to engage the threads on the first part, the bottom having a cleaning member disposed on the bottom, the cleaning member configured with a plurality of cleaning elements disposed thereon,
wherein, with the first part and the second part engaged, at least half of the second end effector is disposed on a second side of the plane that extends along the longitudinal axis, and
wherein the plurality of cleaning elements of the first end effector have a first form factor and the plurality of cleaning elements of the second end effector have a second form factor that is different from the first form factor.

19. The kit of claim 16, wherein the interface has a landing surface disposed between the longitudinal axis and the side portion, the landing surface forming an arc that extends convexly from the longitudinal axis to a side portion of the interface that is laterally offset from the longitudinal axis.

20. The kit of claim 19, wherein the landing surface has a grip disposed thereon with surface properties that are different from surface properties of the first member.
